(19) United States
(12) Patent Application Publication
(10) Pub. No.: US 2026/0287475 A1
(43) Pub. Date: Sep. 24, 2026

(54) ASPIRATION SYSTEM FOR MEASURING THE VOLUME OF AN ASPIRATED SAMPLE

(71) Applicant: Beckman Coulter, Inc., Brea, CA (US)

(72) Inventor: Marco Zuleta, Brea, CA (US)

(21) Appl. No.: 19/571,142

(22) Filed: Mar. 18, 2026

Related U.S. Application Data
(60) Provisional application No. 63/775,702, filed on Mar. 21, 2025.

(51) Int. Cl. G01N 1/14

(52) U.S. Cl. CPC G01N 1/14; G01N 2001/1418

(57) ABSTRACT

An aspiration system for a biological analyzer includes: an aspiration needle configured to aspirate a biological sample from a specimen vial; a measurement circuit configured to measure a resistance of the biological sample in the aspiration needle; and a processor configured to assess the resistance of the biological sample to estimate a cell count result to assess at least one of a volume of the biological sample or an integrity of the biological sample.

### CROSS REFERENCE TO RELATED APPLICATIONS

The present application claims the benefit of U.S. Provisional Application No. 63/775,702, filed on Mar. 21, 2025, the entirety of which is incorporated by reference herein.

### BACKGROUND

Generally, this disclosure relates to aspiration systems that aspirate a sample (e.g., a biological sample, such as human blood) for analysis by one or more processes. In particular, the application relates to detecting a volume of fluid (e.g., a biological sample, a gas such as air, or a diluent) in an aspiration needle. One challenge with aspiration is determining whether a sufficient amount of a sample has been aspirated to allocate sufficient volumes for each sample aliquot – which is important in establishing accurate cell counts for patient sample analysis.

One known solution is to use an absorption sensor or detector to measure the volume of the aspirated sample. Such a detector may be located in a different location in the system, such as relatively far away from the aspiration needle or probe. Moving the sample an additional distance through the tubing requires additional movement of the aspirated sample. However, lengthening the path of transportation of the aspirated sample within tubing can, in the case of a biological sample with cells, may alter the proportionality of the different cell populations, thereby altering this proportionality in the aliquots and decreasing accuracy of the analysis processes.

There is therefore a need for aspiration systems that improve performance with respect to one or more of the aforementioned issues.

### SUMMARY

According to embodiments, an aspiration system comprises: an aspiration needle configured to aspirate a biological sample from a specimen vial; a measurement circuit configured to measure a resistance of the biological sample in the aspiration needle; and a processor configured to assess the measured resistance of the biological sample to estimate a cell count result to assess at least one of a volume of the biological sample or an integrity of the biological sample. The aspiration needle may include a probe. The measurement circuit may include a conductive region configured to form a conductive pathway to the biological sample. The measurement circuit may be configured to measure the resistance of the biological sample when a modulation signal is applied at the conductive region of the measurement circuit. The aspiration needle may be grounded. The measurement circuit may be configured to measure the resistance of the biological sample during a dispensation of an aliquot when the modulation signal is applied at the conductive region of the measurement circuit during an initial dispensing of the biological sample. The measurement circuit may be configured measure the resistance of the biological sample by: generating an electrical signal; measuring an output of an analog to digital convertor; utilizing a capacitor to block a direct current during an active cycle of the electrical signal; and determining an output signal as proportional to resistances in a voltage divider, including a resistor and a resistance of the biological sample.

According to embodiments, a method of assessing a biological sample comprises: providing an aspiration needle for aspirating the biological sample from a specimen vial; measuring a resistance of the biological sample in the aspiration needle; and assessing the resistance of the biological sample to estimate a cell count estimation to assess at least one of a volume of the biological sample or an integrity of the biological sample. The method may further comprise: reducing dilution effects using an air separator; cleaning the aspiration needle; identifying a short sample condition; delivering different ones of a plurality of portions of the biological sample to different assessment systems; and discarding a portion of the biological sample before delivering the different ones of the plurality of portions of the biological sample to each different assessment system to align the biological sample to a tip of the aspiration needle before performing further dispensation. The aspiration needle may include a probe. Measuring the resistance of the biological sample may be performed at least in part by a measurement circuit comprising a conductive region configured to form a conductive pathway to the biological sample. Measuring the resistance of the biological sample may include applying a modulation signal at the conductive region of the measurement circuit. The aspiration needle may be grounded. Measuring a resistance of the biological sample in the aspiration needle may further comprise: generating an electrical signal; measuring an output of an analog to digital convertor; utilizing a capacitor to block a direct current during an active cycle of the electrical signal; and determining an output signal as proportional to resistances in a voltage divider, including a resistor and a resistance of the biological sample.

### BRIEF DESCRIPTION OF SEVERAL VIEWS OF THE DRAWINGS

FIG. 1 is a schematic illustration, in section and not to scale, showing an aspiration needle retaining a sample, an air separator, and a diluent.

FIG. 2 is a block diagram of an aspiration system retaining a sample, according to embodiments.

FIG. 3 is a schematic illustration, in section and not to scale, showing an aspiration system including an aspiration needle retaining a sample, an air separator, and a diluent, according to embodiments.

FIGS. 4A, 4B, and 4C is a schematic illustration, in section and not to scale, showing an aspiration system of FIG. 3 a diluent, an air separator, and different amounts of a sample (different amounts in FIGS. 4A, 4B, 4C, respectively), according to embodiments.

FIG. 5 is a timing diagram for a modulation signal and a sensed signal, according to embodiments.

FIG. 6 is a flowchart for a method of aspirating and dispensing a sample, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

Embodiments disclosed herein measure volumes and/or the presence of fluids in an aspiration needle using an aspiration system. The volumes or presences can include the volume or presence of an aspirated sample in the aspiration needle and/or a diluent in the aspiration needle. Embodiments can also sense the presence of a gas in the aspiration needle. One example of a gas is air, which is referred to herein, although other gasses are considered.

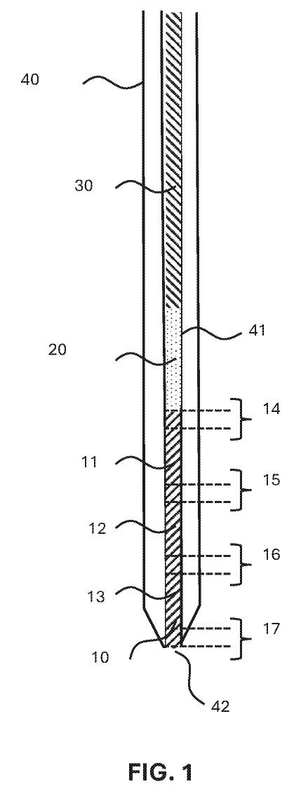

An aspiration needle is used to draw a biological sample (e.g., from a specimen vial) and provide the biological sample to one or more assessment systems in an instrument. FIG. 1 shows an aspiration needle 40, which includes an inner lumen 41 that retains fluid. The fluid can flow through the distal aperture 42, either during aspiration or dispensation. The aspiration needle 40 includes a probe that is used to aspirate a sample 10 held in a container (not shown), such as human blood in a vial. As shown in FIG. 1, the sample 10 has already been aspirated. The aspiration needle 40 also dispenses fluid through the distal aperture 42 of the probe.

A diluent 30 is also retained by the lumen 41. The diluent 30 may cleanse different blood-contacting components of the instrument system (e.g., aspiration needle and probes) after each sample analysis in order to prevent sample carry-over from one analysis to another.

An air separator 20 (a region of air or gas) in the lumen 41 is interposed between the diluent 30 and sample 10. The air separator 20 can isolate the diluent 30 from the sample 10. The air separator 20 can preserve the integrity of the aspirated sample 10 to reduce dilution effects in the initial part of the aspirated sample 10 that enters into the aspiration needle 40 and to increase the amount of sample 10 suitable for analysis.

After the sample 10 is aspirated and the probe exterior is cleaned the aspiration needle 40 is ready to deliver aliquots to different analysis processes or assessment systems. The sample 10 includes different portions for dispensation, including three aliquots 11, 12, 13, each surrounded by a discard portion 14, 15, 16, 17. Discard portion 14 is above aliquot 11 and separates aliquot 11 from the air separator 20. Discard portion 15 is between aliquot 11 and aliquot 12. Discard portion 16 is between aliquot 12 and aliquot 13. Discard portion 17 is between aliquot 13 and the distal aperture 42.

The aliquots 11, 12, 13 are used for different analysis or assessment processes. The aliquots 11, 12, 13 can be delivered to different assessment systems or processes for assessment. Such assessment systems or processes can analyze a sample to determine a red blood cell (RBC) count, a platelet count, and/or hemoglobin analysis. Another exemplary process is RBC imaging, which can analyze a sample to determine a RBC count. Another exemplary process is white blood cell (WBC) imaging, which can be used to determine WBC count and/or platelet count.

The aliquots 11, 12, 13 can be used or provided to an imaging assessment system or a non-imaging assessment system. One example of a non-imaging assessment system is an impedance measurement system, sometimes referred to as a Coulter counter. Other types of non-imaging systems are contemplated. The aliquots 11, 12, 13 can each be provided to a different assessment system – e.g., imaging and/or non-imaging assessment systems.

Before a given aliquot is dispensed for an analysis process, a discard portion below the aliquot is discarded via dispensation. Before aliquot 13 is dispensed, discard portion 17 is discarded. Before aliquot 12 is dispensed, discard portion 16 is discarded. Before aliquot 11 is dispensed, discard portion 15 is discarded. After aliquot 11 is dispensed, discard portion 14 is dispensed. Discarding assists in aligning the sample 10 at the distal aperture 42 before dispensing. There may be more or fewer aliquots and corresponding discard portions in an aspirated sample 10.

After the aliquots 11, 12, 13 and discard portions 14, 15, 16, 17 are dispensed, the air separator 20 is dispensed. Then the diluent 30 is dispensed to clean sample-contacting portions of the aspiration needle 40, including the lumen 41.

One concern is whether a sufficient amount of a sample 10 has been aspirated to allocate sufficient volumes for the aliquots 11, 12, 13 and corresponding discard portions 14, 15, 16, 17. If, for example, there was insufficient volume of the sample 10 in the vial, the aspirated amount of the sample 10 may be too low.

According to embodiments, an aspiration needle includes an inner lumen, which retains the fluids. A probe (or a portion of the probe, as will be further understood) at a distal region of the aspiration needle is electrically conductive and extends to the inner lumen. A conductive path is thereby formed between the retained fluid and the conductive region in the probe. This conductive region need not be in the probe itself, but optionally in another region of the aspiration needle.

According to embodiments, another conductive region is located proximal from the lower conductive region. The upper conductive region can also extend to the inner lumen, thereby creating a conductive path between the retained fluid and the upper conductive region. Such an upper conductive region can be formed using a conductive fitting located along the path of the flow of fluids through the inner lumen.

According to embodiments, the upper and lower conductive regions are separated by a non-conductive region, thereby electrically isolating the conductive regions from each other. When the conductive regions are at different voltages from each other, current can only flow through the fluid in the inner lumen. The aspiration system creates a voltage differential between the conductive regions to assess the conductance or resistance of the fluid extending between the conductive regions in the aspiration needle. As used herein, the term “resistance” includes the concept of “conductance,” as resistance and conductance are reciprocals of each other and generally refer to the ability of a circuit, fluid, or media to facilitate the flow of electrons.

According to embodiments, an excitation signal is applied to one of the conductive regions. The other one of the conductive regions can be connected to another part of the circuit, such as ground. For example, the upper conductive region can receive the excitation signal, whereas the lower conductive region can be grounded (or vice versa). Grounding could be achieved by electrically connecting (e.g., shorting) one of the conductive regions to the chassis of the instrument. The excitation signal can be a modulation signal, such as a pulse-width modulated (PWM) signal. As the excitation signal is applied, the voltage differential between the conductive regions or magnitude of current flowing between the conductive regions can be measured to determine a volume of the sample between the conductive regions in the aspiration needle. In the case of measuring the voltage, a voltage divider can be implemented. Such a measurement indicates resistance of the fluid in the inner lumen of the aspiration needle.

According to embodiments, the volume of the sample may be determined or inferred according to an estimated cell count in the sample. A greater number of cells along the electrical path between the conductive regions corresponds to a greater resistance. Based on the expected concentration of the cells (e.g., red blood cells) in the sample, the volume of the sample can be inferred.

According to embodiments, the resistance of the fluid can indicate the identity of the fluid and/or the volume of the fluid in the aspiration needle. For example, if air is between all of or a portion of the conductive regions, the measured resistance will be relatively high, because air is an insulator.

According to embodiments, as another example, if an aspirated sample is between the conductive regions, the resistance will be relatively lower. The particular resistance can indicate the volume of the aspirated sample.

According to embodiments, as another example, if a diluent is between the conductive regions, the resistance may generally fall into a range that is distinguishable from a range expected for an aspirated sample. The aspiration system can then determine the presence and/or the volume of the diluent. Further, temperature effects in resistance could also be accounted for with a resistance measurement of diluent.

According to embodiments, in the case of an aspirated sample, the aspiration system can determine whether a sufficient quantity of sample has been aspirated to account for the aliquots and discard regions. If an insufficient amount of sample has been aspirated, then the aspiration system can take appropriate action (e.g., notify an operator of the instrument). By assessing the resistance of the aspirated sample, the expected erythrocyte range can be inferred. The volume information of the sample or expected erythrocyte range can be compared with the results of other analysis processes. For example, an expected erythrocyte count can be compared with the actual erythrocyte count from the impedance and/or imaging analysis processes to corroborate the aspiration sample integrity. These different analysis processes also produce results that can be cross examined for aspiration integrity. Other examples of aspiration sample integrity include whether or not there are bubbles in the sample.

According to embodiments, as an example, assuming relatively little sample in the specimen vial not sufficient to complete the aspiration, the circuit would measure relatively high resistance due to the presence of air between the conductive regions. The aspiration system may infer (or estimate) a cell count with a relatively large erythrocyte count due to the relatively high resistance. However, since no or relatively little blood is delivered to the analysis process(es), the actual erythrocyte count will be very low and the sample could be flagged because of the discrepancy.

According to embodiments, as another example, if there is enough sample (in this example, human blood) to completely cover the measuring volume but not enough to fully prime the probe with the sample, an impedance analysis process (which in this example is the first one to be aliquoted) will not have sufficient blood and the derived RBC count will not match the expected count based on the measured volume above the probe. Again, the sample could be flagged.

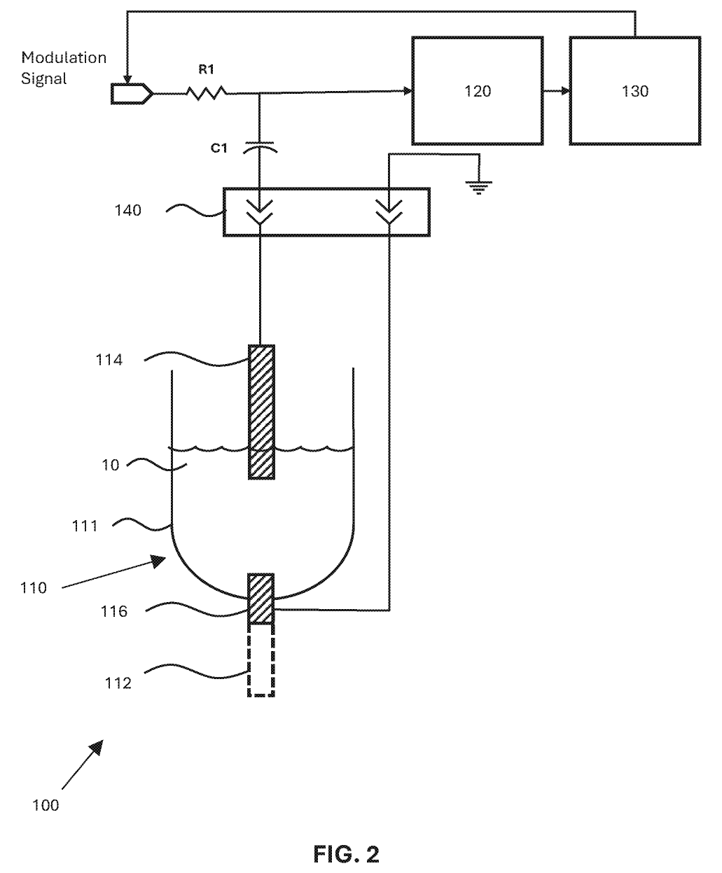

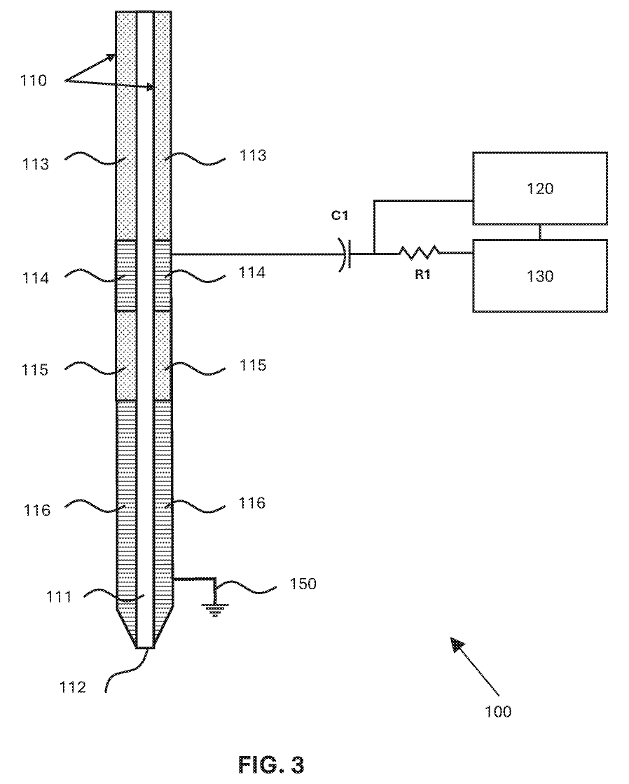

FIG. 2 is a representation of an aspiration system 100, according to embodiments. The embodiment of the aspiration system 100 depicted includes an aspiration needle 110, a measurement circuit 120, a processor 130, and a connector 140. Embodiments of the aspiration needle 110 are illustrated in greater detail in, for example, FIG. 3. The aspiration needle 110 includes a lumen 111 that holds a sample 10 (e.g., human blood). The sample 10 may have been aspirated from a container, such as a vial (not shown). The aspiration needle 110 further includes a distal aperture 112, through which the sample 10 can be aspirated or dispensed. The aspiration needle 110 further includes two conductive regions 114, 116 (a first conductive region 114, and a second conductive region 116, respectively). The first and second conductive regions 114, 116 can be located such that they are in contact with a typical aspirated sample 10. The first and second conductive regions 114, 116 include one or more conductive materials, such as stainless steel.

The sample 10 has a region with a resistance that electrically connects the first conductive region 114 with the second conductive region 116. The first and second conductive regions 114, 116 are electrically isolated from each other when there is no sample 10 in the lumen 111. One of the first or second conductive regions 114, 116 can be grounded (or not). As shown, the second conductive region 116 is grounded, but the first conductive region 114 may be grounded instead. The other one of the first or second conductive regions 114, 116 (as shown, the first conductive region 114) is connected to another part of a circuit. As shown, the first conductive region 114 is connected to capacitor C1.

The first and/or second conductive regions 114, 116 can be connected to other parts of a circuit via a connector 140. Examples of a connector 140 include a metal fitting, pin, plug, socket, PCB connectors, or other connectors 140 that can connect with wires.

The measurement circuit 120 has an input that has a voltage during operation. The measurement circuit 120 can include an analog-to-digital converter that converts an analog input value (the analog value of the voltage) to a corresponding digital value and outputs the digital value. An output of the measurement circuit 120 is electrically connected to the processor 130. The measurement circuit 120 and the processor 130 may be separate components or may be integrated on a single chip. The processor 130 receives the output of the measurement circuit 120 and executes a set of instructions that evaluates the output (e.g., digital value of voltage) of the measurement circuit 120.

The processor 130 further causes a modulation signal to be generated. The modulation signal includes a modulated signal, such as a pulse-width modulation (PWM) signal. The frequency of the modulation signal may be between 2 KHz and 25 MHz. The frequency of the modulation signal may be constant or may vary over time.

The modulation signal is applied to the circuit, and as shown, to resistor R1. As shown, the other side of the resistor R1 is electrically connected to the capacitor C1. The modulation signal may pass through a component between the processor 130 and the resistor R1, such as a digital-to-analog converter (not shown). The modulation signal may have a peak-to-peak voltage of between 3 and 5 Volts. The peak-to-peak voltage may be constant or may vary. Voltage may be selected such that the aspiration system 100 will not perform electrolysis on the sample 10. The modulation signal has an active phase when the signal is being driven high or not zero volts.

The resistor R1 may have a resistance that generally matches the resistance of a typical aspirated sample 10. For example, the resistance of the resistor R1 may be between 100 and 250 kΩ, such as 150 kΩ.

The capacitor C1 may have a capacitance providing a relatively negligible impedance at the frequency of the modulation signal. For example, the capacitance of the capacitor C1 may be between 1 and 10 µF. The capacitor C1 serves to block direct current from the modulation signal, for example, when the modulation signal is high.

The side of the capacitor C1 that is not electrically connected to the resistor R1 is shown as being electrically connected to the first conductive region 114 via the connector 140. The resistance of resistor R1 and the resistance of the sample 10 form a voltage divider. If the modulation signal is constant, then the voltage inputted to the measurement circuit 120 will be proportional to the resistance of the sample 10. As the resistance of the sample 10 changes (e.g., the volume of the sample 10 changes and/or the cell count in the sample 10 changes), then the voltage inputted to the measurement circuit 120 will change as well. The processor 130 can make determinations about properties of the fluid(s) between the first conductive region 114 and the second conductive region 116. For example, in the case of an aspirated sample 10, the processor 130 can make a determination about the volume of the sample 10 based on the voltage inputted to the measurement circuit 120.

FIG. 3 illustrates the aspiration needle 110, according to embodiments. The circuit shown in FIG. 3 is similar to that shown and described with respect to FIG. 2. The second conductive region 116 may be, or may be part of a probe of the aspiration needle 110. In an embodiment, the second conductive region 116 is the entirety of the probe (e.g., one that includes stainless steel).

The conductive regions 114, 116 each can extend to the outer surface of the lumen 111 (or therein). Only one of the conductive regions 114, 116 may extend inwardly from the outer surface of the lumen 111. The conductive region 114 may be positioned above the probe.

As shown, the conductive region 116 is grounded and the excitation signal (via C1 is applied to the conductive region 114, although the conductive region 116 may be grounded and the excitation signal may be applied to the conductive region 114. Optionally, neither of the conductive regions 114, 116 may be grounded, but they still are part of a circuit path along which the resistance of the fluid between the conductive regions 114, 116 can be measured.

Interposed between the conductive regions 114, 116 is a non-conductive region 115. The non-conductive region 115 may extend to the outer surface of the lumen 111 (or into the lumen 111). The non-conductive region 115 may include an insulating material, such as plastic, Teflon, polyethylene, or the like. According to an embodiment, the non-conductive region 115 may be tubing of the aspiration needle 110. The non-conductive region 115 prevents current from flowing directly between the conductive regions 114, 116.

Above the conductive region 114 is another non-conductive region 113. The non-conductive region 113 may be similar to the non-conductive region 115.

The height of the conductive region 114 may be selected according to the volume to be detected. According to embodiments, the height of the conductive region 114 is selected such that the conductive region 114 contacts a portion of the aspirated sample 10 in the inner lumen 111 based on a typical volume (or typical range of volumes) of the aspirated sample 10. For example, the conductive region 114 may have a height such that a portion of the aspirated sample 10 may touch the conductive region 114, even for the case of a minimum acceptable volume of the aspirated sample 10. The height of the conductive region 114 may be adjustable or static. The conductive region 114 may be one contiguous region, or the conductive region 114 could include two or more distinct conductive regions.

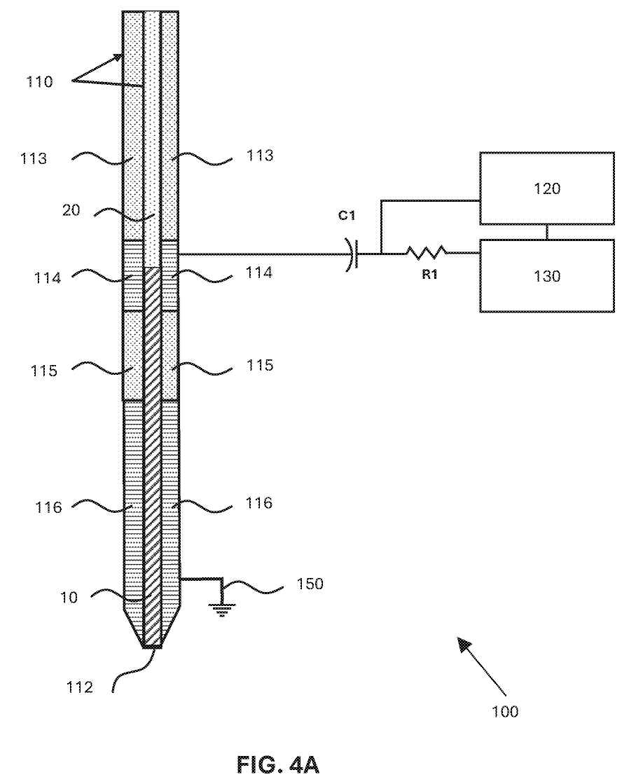

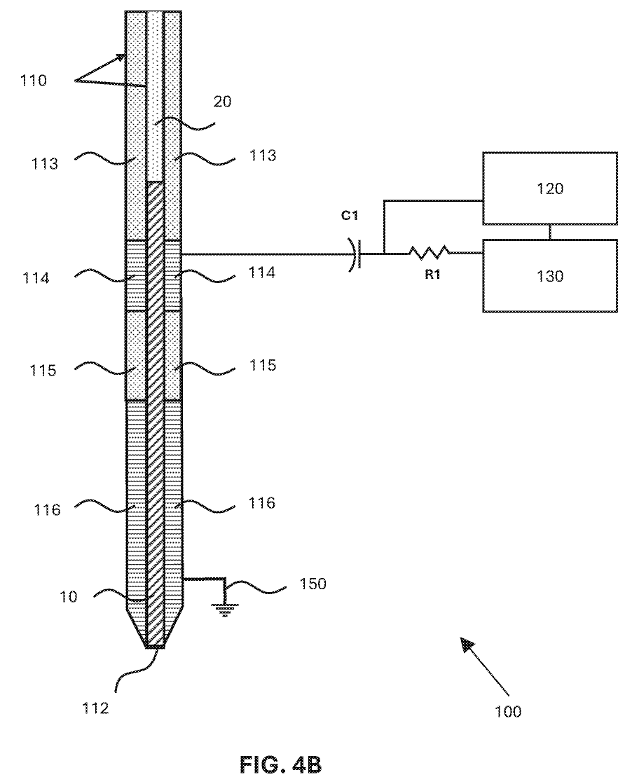

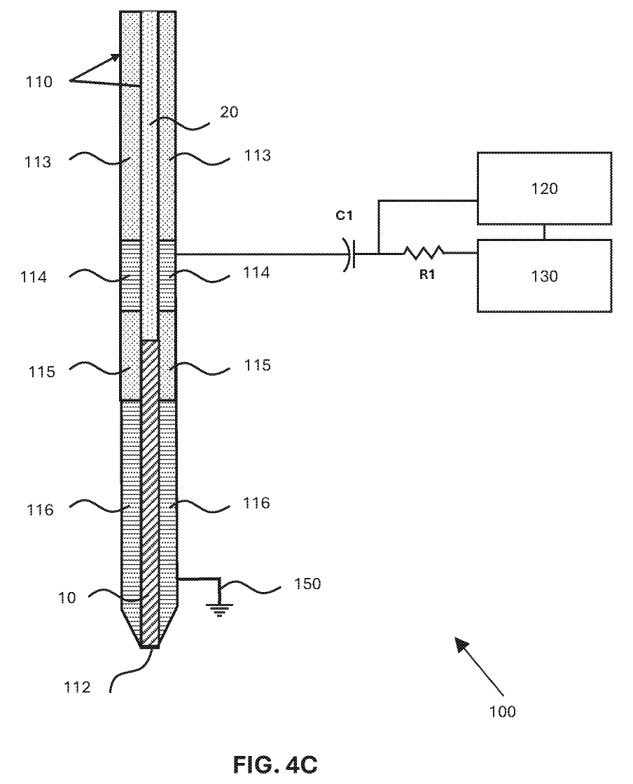

FIGS. 4A, 4B, and 4C show three different examples of different volumes of aspirated samples 10 in the inner lumen 111 of the aspiration needle 110. In FIG. 4A, the height of the aspirated sample 10 extends to about the middle of the height of the conductive region 114. In FIG. 4B, there is a greater volume of the aspirated sample 10 in the inner lumen 111, and the height of the aspirated sample 10 extends above the conductive region 114. FIG. 4C shows a short sample condition, where there is a relatively small volume of the aspirated sample 10 in the inner lumen 111. In this example, the aspirated sample 10 has a maximum height below the conductive region 114.

In the example of FIG. 4A, because there is a contiguous volume of the aspirated sample 10 in the electrical path between the conductive regions 114, 116, the resistance of the aspirated sample 10 is relatively low. The voltage in the middle of the voltage divider (formed by R1 on the top and the resistance of the aspirated sample 10 on the bottom) is relatively low, and the measurement circuit 120 detects this voltage. This voltage information is communicated to the processor 130, which determines the volume or other characteristic(s) of the aspirated sample 10 based on the voltage.

In addition to assessing a DC voltage, the processor 130 can make determinations about the characteristic(s) of the aspirated sample 10 according to the frequency response of the aspirated sample 10. When the volume of the aspirated sample 10 is sufficiently large to account for the aliquots and discard portions, a determination can be made that the amount of aspirated sample 10 is sufficient for distribution to the analysis process(es).

If there is not a continuous path of the aspirated sample 10 between the conductive regions 114, 116, and there is air in the column (either above, below, or in the middle of the column of the aspirated sample 10), then the resistance of the fluid path between the conductive regions 114, 116 will be relatively high. The processor 130 can make this determination and cause appropriate action to be taken.

In the example of FIG. 4B, there is also a contiguous volume of the aspirated sample 10 in the electrical path between the conductive regions 114, 116. As compared to FIG. 4A, there is more of the aspirated sample 10 in the electrical path between the conductive regions 114, 116. In this case, the processor 130 will still determine that there is a relatively low resistance of the aspirated sample 10, but the resistance will be higher than with the resistance measured in FIG. 4A due to there being a greater volume of the aspirated sample 10. The processor 130 can then assess the volume or integrity of the aspirated sample 10.

In the example of FIG. 4C, the height of the column of the aspirated sample 10 does not reach the conductive region 114. Instead, air 20 extends upwardly from the upper surface of the aspirated sample 10 in the inner lumen 111, and the air 20 contacts the conductive region 114. Because the air 20 has a high resistance, the processor 130 can determine its presence. In such a case, the processor 130 may determine that there is a short sample condition or that there is some other issue with the integrity of the aspirated sample 10 such as an air bubble in the column of the aspirated sample 10, and optionally cause appropriate action to be taken.

The examples of FIGS. 4A, 4B, and 4C are based on there being no dynamic flow of fluid(s) in the inner lumen 10—i.e., the column of fluid is static. As fluid flows, the aspiration system 100 via assessment by the processor 130 can, over time, dynamically assess the volume or constitution of the fluid column between the conductive regions 114, 116. For example, the aspiration system 100 via assessment by the processor 130 can assess the rate of aspiration or dispensation of fluids in the aspiration needle 110. The aspiration system 100 via assessment by the processor 130 can also detect and assess the amount of the aspirated sample 10 that is dispensed—e.g., the volume(s) of the discard portions and/or the aliquots, individually or collectively.

The aspiration system 100 via assessment by the processor 130 can measure the volume of the sample 10 as portions of the sample are delivered or dispensed. For example, the aspiration system 100 via assessment by the processor 130 can measure the volume of the sample 10 before delivery or dispensation. Then, after the discard portion 17 is delivered or dispensed, the volume of the sample 10 can be measured. The aspiration system 100 via assessment by the processor 130 can further determine the difference of the volumes of the sample 10 before and after the discard portion 17 was delivered or dispensed, thereby determining the volume of the discard portion 17 that was delivered or dispensed. A similar process can be performed by the aspiration system 100 via assessment by the processor 130 to determine the volumes of the aliquots 11, 12, and/or 13, and/or the discard portions 14, 15, and/or 16.

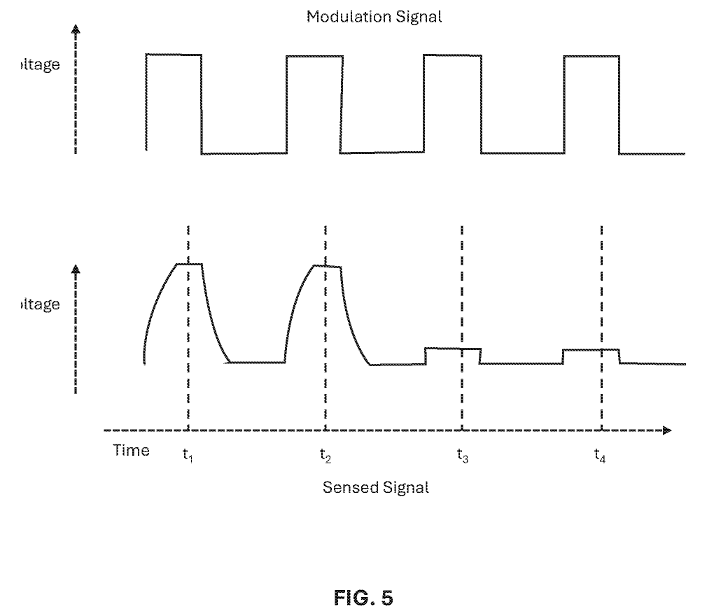

FIG. 5 shows an exemplary timing diagram of the modulation signal generated or caused by the processor 130 as well as the sensed voltage, both over time. In embodiments described herein, the modulation signal is the signal at the top of the voltage divider and the sensed signal is the signal in the middle of the voltage divider between R1 and the resistance of the column of the fluid(s) in the electrical path between the conductive regions 114, 116. The modulation signal is shown as a square wave with pulsed widths of a given duty cycle. That duty cycle can be modulated according to pulse-width modulation (PWM). The sensed signal responds to these pulses. After a certain period of time, the voltage of the sensed signal stabilizes (becomes substantially constant over time). Once stabilized (or expected to be stabilized), a measurement of the sensed signal can be taken. These times are shown as t₁, t₂, t₃, and t_{4.}

The first two pulses are when air is between the electrical path between the conductive regions 114, 116. Because the resistance of air is relatively high (Rₐᵢᵣ >> R1), the measured voltages at t₁ and t₂ are relatively high. Thus, when such a voltage is measured, the presence of air in the electrical path between the conductive regions 114, 116 can be inferred.

The second two pulses are when an aspirated sample forms a contiguous path along the electrical path between the conductive regions 114, 116. Because the resistance of the aspirated sample is relatively low, the measured voltages at t₃ and t₄are relatively high. Based on this voltage, the cell count (e.g., erythrocyte count) can be estimated, and the volume of the aspirated sample can be inferred therefrom.

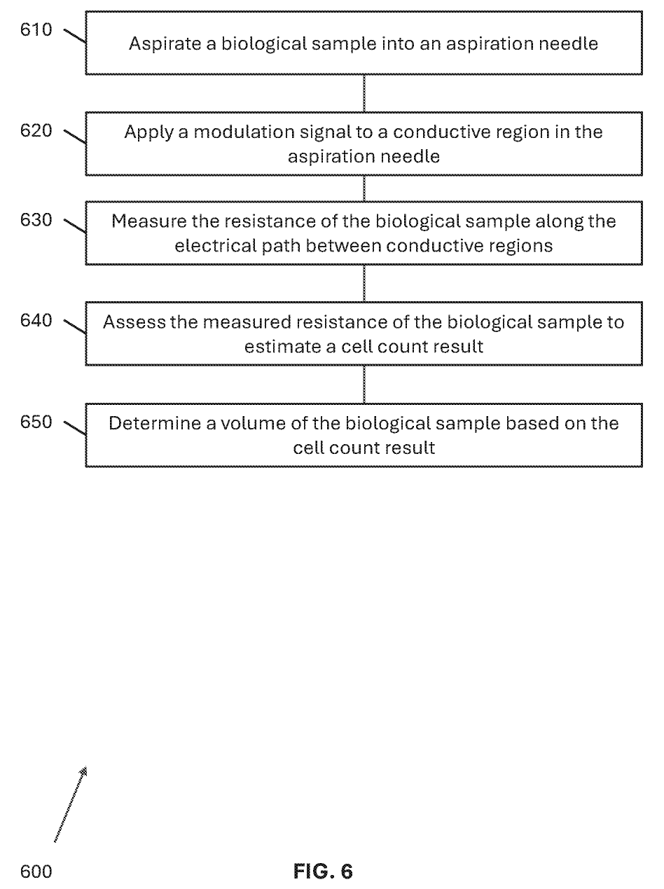

FIG. 6 is a flowchart 600 for a method for assessing a function of a biological analyzer, according to embodiments. The steps in flowchart 600 may be performed by an aspiration system, such as aspiration system 100. The steps in flowchart 600 may be implemented by a computer. For example, the steps in flowchart 600 may be performed by a processor, such as processor 130. The steps may be performed when the processor executes instructions stored on a computer-readable memory (e.g., a non-transitory memory). Flowchart 600 is described in conjunction with aspiration system 100, but is not so limited.

At step 610, a biological sample 10 (e.g., human blood) is aspirated into an aspiration needle 110. Before aspiration, the biological sample 10 can be in a specimen vial. As described above, the aspiration needle 110 includes conductive regions 114, 116. The aspirated sample 10 can contact the lower conductive region 116 and/or the upper conductive region 114.

At step 620, a modulation signal (e.g., PWM signal) is applied to one of the conductive regions 114, 116. In an embodiment, the modulation signal is applied to the conductive region 114. The processor 130 may cause the modulation signal to be generated, such that it is applied to one of the conductive regions 114, 116.

At step 630, the resistance of the biological sample 10 in the electrical path between the conductive regions 114, 116 is measured. The resistance may be measured by the measurement circuit 120 and the processor 130. As described above, the resistance of the biological sample 10 may be determined using a voltage divider, where one side of the voltage divider is a known resistance (e.g., R1), and the other side of the voltage divider is the biological sample 10 in the electrical path between the conductive regions 114, 116. As current flows through the voltage divider, voltage can be measured between the known resistance and the resistance of the biological sample 10. From this voltage, the resistance of the biological sample 10 can be determined.

At step 640, a cell count result in the biological sample 10 is estimated based on the resistance measured in step 630. Such a cell count estimation may be an estimation of erythrocyte count in the biological sample 10. The processor 130 may make such an estimation, for example, based on a lookup table or algorithm that can correlate resistance with a number of cells (e.g., erythrocyte cells).

At step 650, the volume of the biological sample 10 in the aspiration needle 110 can be estimated or determined. Such an estimation or determination can be performed by the processor 130. Using the cell count result in step 640, the volume of the biological sample 10 can be inferred based on an assumption of the concentration of erythrocytes in the biological sample 10. The cell count can be divided by the concentration to arrive at the volume.

The volume information can be used to determine if the volume of the biological sample 10 is sufficient or what was expected. If not, the processor 130 may flag a short sample condition. And as discussed, the volume information can be used with previous measurements to determine the volume of portion(s) of the biological sample 10, such as the aliquots 11, 12, 13 and/or the discard portions 14, 1516, 17.

The operations described herein may be performed or effected using a computer or other processor (e.g., processor 130) having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the disclosure have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the disclosure, a single component may be replaced by multiple components, and multiple components may be replaced by a single component, to provide an element or structure or to perform a given function or functions.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. An aspiration system for a biological analyzer, comprising:
an aspiration needle configured to aspirate a biological sample from a specimen vial;
a measurement circuit configured to measure a resistance of the biological sample in the aspiration needle; and
a processor configured to assess the resistance of the biological sample to estimate a cell count result to assess at least one of a volume of the biological sample or an integrity of the biological sample.

2. The aspiration system of claim 1, wherein the processor is configured to estimate the cell count result to assess the volume of the biological sample.

3. The aspiration system of claim 1, wherein the processor is configured to estimate the cell count result to assess the integrity of the biological sample.

4. The aspiration system of claim 1, wherein the aspiration needle includes a probe.

5. The aspiration system of claim 1, wherein the measurement circuit includes a conductive region configured to form a conductive pathway to the biological sample, and wherein the conductive region is grounded and is further configured to contact the biological sample.

6. The aspiration system of claim 5, wherein the measurement circuit is configured to measure the resistance of the biological sample when a modulation signal is applied at the conductive region of the measurement circuit, and wherein the measurement circuit comprises a pulse width modulation (PWM) signal.

7. The aspiration system of claim 5, wherein the measurement circuit is configured to measure the resistance of the biological sample during a dispensation of the biological sample when the modulation signal is applied at the conductive region of the measurement circuit.

8. The aspiration system of claim 1, wherein the aspiration needle is grounded.

9. The aspiration system of claim 1, wherein the measurement circuit is configured measure the resistance of the biological sample by:
generating an electrical signal;
measuring an output of an analog to digital convertor;
utilizing a capacitor to block a direct current during an active cycle of the electrical signal; and
determining an output signal as proportional to resistances in a voltage divider, including a resistor and the resistance of the biological sample.

10. The aspiration system of claim 9, wherein the capacitor is between the resistor and the biological sample.

11. An aspiration system for a biological analyzer, comprising:
an aspiration needle configured to aspirate a biological sample from a specimen vial; and
a processor configured to:
receive a resistance of the biological sample located in the aspiration needle; and
assess the resistance of the biological sample to estimate a cell count result to assess at least one of a volume of the biological sample or an integrity of the biological sample.

12. The aspiration system of claim 11, wherein the processor is configured to estimate the cell count result to assess the volume of the biological sample.

13. The aspiration system of claim 12, wherein the processor is configured to assess a volume of a discard portion of the biological sample.

14. The aspiration system of claim 11, wherein the processor is configured to estimate the cell count result to assess the integrity of the biological sample.

15. The aspiration system of claim 11, wherein the aspiration needle includes a probe.

16. The aspiration system of claim 11, wherein the processor is configured to cause a modulation signal to be generated to measure the resistance of the biological sample.

17. The aspiration system of claim 16, wherein the modulation signal is a pulse-width modulation signal.

18. The aspiration system of claim 11, wherein the aspiration needle is grounded.

19. The aspiration system of claim 11, wherein the processor is configured to receive the resistance of the biological sample during a dispensation of the biological sample.

20. The aspiration system of claim 19, wherein the processor is configured to assess a rate of dispensation of the biological sample.
